(19) United States
(12) Patent Application Publication
(10) Pub. No.: US 2014/0365327 A1
(43) Pub. Date: Dec. 11, 2014

(54) REVERSE AUCTION FOR REAL-TIME SERVICES

(71) Applicants: Steve Crossan, Palo Alto, CA (US); Stanley Chen, Mountain View, CA (US); Douwe Osinga, Sydney (AU)

(72) Inventors: Steve Crossan, Palo Alto, CA (US); Stanley Chen, Mountain View, CA (US); Douwe Osinga, Sydney (AU)

(73) Assignee: GOOGLE INC., Mountain View, CA (US)

(21) Appl. No.: 13/250,145

(22) Filed: Sep. 30, 2011

Related U.S. Application Data
(60) Provisional application No. 61/388,706, filed on Oct. 1, 2010.

(51) Int. Cl. G06Q 30/08

(52) U.S. Cl. 705/26.4

(57) ABSTRACT

Methods, systems, and apparatus, including computer programs encoded on a non-transitory computer storage medium, for providing reverse auctions for goods and services in real-time. In one aspect, a method includes storing profile information associated with a plurality of information sources, each source associated with a category. A request for information from a user including information associated with a good or service sought is analyzed to identify information sources as responsive to the request based on a comparison of the good or service sought and each information source's associated category. Responses are solicited from the identified information sources. In response, a set of responses from at least a subset of the identified information sources is received, which are then ranked based on a comparison of the particular response to the request for information, and at least a subset of which are presented to the user based on the ranking.

### CLAIM OF PRIORITY

This application claims priority under 35 U.S.C. §119 to U.S. Provisional Application No. 61/388,706, filed Oct. 1, 2010, the entire disclosure of which is incorporated herein by reference.

### BACKGROUND

This specification generally relates to facilitating connections and communication between users and information sources.

Users of search engines can locate information by entering queries and receiving lists of results identified by the search engines in response to the queries. Search engine results pages may also include advertisements related or responsive to the queries. A user who wishes to learn more about a particular advertiser may click a link associated with the advertiser to visit an advertiser's website. A channel for communication between the user and the advertiser may or may not be available at the website.

Users looking for a particular product or service online have a number of options when searching for providers. For example, users may visit a particular online retailer and search their catalogs and listing of services, view an aggregator site collecting multiple offers, contact a particular retailer directly with a request for particular goods or services, consult a local business directory, or use a search engine with keywords associated with the desired good or service.

### SUMMARY

This specification describes technologies relating to systems and methods for allowing entities to respond to user requests for goods and/or services.

In general, one innovative aspect of the subject matter described in this specification can be embodied in methods that include the actions of (i) storing profile information associated with a plurality of information sources, each information source associated with at least one category; (ii) analyzing, by operation of a computer processor, a request for information from a user where the request includes information associated with at least one good or service sought; (iii) determining, by operation of a computer processor, one or more information sources as responsive to the request based at least in part on a comparison of the information associated with the at least one good or service sought and the at least one category associated with each information source, wherein information sources include at least one of a merchant or service provider associated with the goods or services sought; (iv) soliciting responses from the one or more identified information sources based on the request for information; (v) in response to the solicitation, receiving a set of responses from at least a subset of the one or more identified information sources; (vi) ranking, by operation of a computer processor, each of the received responses based on a comparison of the particular response to the request for information; and (vi) presenting at least a subset of the received responses to the user based on the ranking of the received responses. Other embodiments of this aspect include corresponding systems, apparatus, and computer programs, configured to perform the actions of the methods, encoded on non-transitory computer storage devices.

These and other embodiments can each optionally include one or more of the following features. For example, the request for information can include at least one of a natural language request or a free-form text-based request. Analyzing the request can include categorizing the request into at least one predefined category. Analyzing the request can include categorizing the request based on at least geographical or vertical information associated with the at least one good or service sought. Analyzing the request can further include categorizing the request based on one or more of the following: demographic information associated with the user, information associated with a profile of the user, and a user-defined category included in the request.

Identifying one or more information sources as responsive to the request can include identifying one or more information sources associated with at least one category associated with the request. Each information source can be associated with a set of routing information. Each set of routing information can include a correspondence address and a communication channel associated with the information source. Further, each correspondence address can include at least one of a really simple syndication (RSS) feed associated with the information source, an email address for the information source, a chat address associated with the information source, or a short message service (SMS) short code associated with the information source. Identifying one or more information sources as responsive to the request can include routing a set of information associated with the request for information from the user to at least one identified information source's correspondence address. Further, routing the set of information to the one or more information sources can include routing the set of information to a first information source via a first communication channel and routing the set of information to a second information source via a second communication channel.

In some instances, ranking each of the received responses can include (i) retrieving the stored profile information associated with each of the one or more identified information sources providing responses to the request for information from the user, (ii) calculating a quality score for each received response based at least in part on the stored profile information associated with the information source corresponding to the received response and the contents of the received response, and (iii) sorting the received responses based on the calculated quality scores. Calculating the quality score for each received response can be further based at least in part on a bid value associated with the information source. In some instances, presenting at least a subset of the received responses to the user based on the ranking of the received responses can include (i) identifying a predefined number of responses to be presented and (ii) limiting the subset of the received responses for presentation to the predefined number of responses. Further, at least one response from the subset of the one or more identified information sources can include an offer for the good or service sought in the request from the user.

In general, another aspect of the subject matter described in this specification can be embodied in an article comprising a computer readable storage medium that stores instructions for causing one or ore processors to perform operations including (i) storing profile information associated with a plurality of information sources, each information source associated with at least one category; (ii) analyzing a request for information from a user where the request includes information associated with at least one good or service sought; (iii) determining one or more information sources as responsive to the request based at least in part on a comparison of the information associated with the at least one good or service sought and the at least one category associated with each information source, wherein information sources include at least one of a merchant or service provider associated with the goods or services sought; (iv) soliciting responses from the one or more identified information sources based on the request for information; (v) in response to the solicitation, receiving a set of responses from at least a subset of the one or more identified information sources; (vi) ranking each of the received responses based on a comparison of the particular response to the request for information; and (vii) transmitting at least a subset of the received responses to the user based on the ranking of the received responses.

These and other embodiments can each optionally include one or more of the following features. For example, analyzing the request can include categorizing the request based on at least geographical or vertical information associated with the at least one good or service sought. Still further, ranking each of the received responses can include (i) retrieving the stored profile information associated with each of the one or more identified information sources providing responses to the request for information from the user; (ii) calculating a quality score for each received response based at least in part on the stored profile information associated with the information source corresponding to the received response and the contents of the received response; and (iii) sorting the received responses based on the calculated quality scores.

In general, another aspect of the subject matter described in this specification can be embodied in a system comprising one or more analysis servers and one or more routing servers. The one or more analysis servers can be adapted to (i) analyze a request for information from a user where the request includes information associated with at least one good or service sought; (ii) categorize the request for information based on at least geographical or vertical information associated with the at least one good or service sought; and (iii) identify at least one information source as responsive to the request based at least in part on a comparison of the categorization of the request for information with the categorizations associated with a plurality of information source, wherein information sources include at least one of a merchant or service provider associated with the goods or services sought. The one or more routing servers can be adapted to (i) store profile information associated with a plurality of information sources, each information source associated with at least one categorization and a set of routing information; (ii) solicit responses to the request for information by transmitting information associated with the request for information to at least one of the identified information sources, where transmitting the information is based on the set of routing information associated with each solicited information source; and (iii) collect a set of responses to the request for information from at least a subset of the solicited information sources. The one or more analysis servers can be further adapted to rank the collected responses based on a quality comparison of each collected response to the request for information from the user and transmit at least a subset of the collected responses to the user based on the ranking of the received responses.

In general, another aspect of the subject matter described in this specification can be embodied in a system that includes (i) means for storing profile information associated with a plurality of information sources, each information source associated with at least one category, (ii) means for analyzing a request for information from a user where the request includes information associated with at least one good or service sought; (iii) means for determining one or more information sources as responsive to the request based at least in part on a comparison of the information associated with the at least one good or service sought and the at least one category associated with each information source, wherein information sources include at least one of a merchant or service provider associated with the goods or services sought; (iv) means for soliciting responses from the one or more identified information sources based on the request for information; (v) means for, in response to the solicitation, receiving a set of responses from at least a subset of the one or more identified information sources; (vi) means for ranking each of the received responses based on a comparison of the particular response to the request for information; and (vii) means for presenting at least a subset of the received responses to the user based on the ranking of the received responses.

Particular embodiments of the subject matter described in this specification can be implemented so as to realize one or more of the following advantages. Users can submit a single request for information and receive a plurality of ranked and filtered results with answers and offers responsive to the request. Users can provide natural language requests that can typically be difficult to enter in normal search engines, and subsequently be provided with offers and responses that address the various details and nuances that can be included in the request. In particular, the system can be designed to accept long, complicated, free text queries (i.e., a complete sentence or paragraph of text) that traditional search engines are not generally equipped to process. These queries can be read and understood by individuals associated with merchants and service providers, allowing human intelligence to govern the generated responses as opposed to automated and/or computer-based assumptions and algorithms, thereby generally providing more relevant and accurate responses to the queries. Further, a plurality of potential merchants and service providers can be contacted by a single request, with each of the responses to the request being ranked and sorted prior to the user receiving them. This ranking and sorting allows users to receive multiple responsive offers in one or more structured messages, allowing the information to presented in a convenient manner. In some instances, the responses to the user's request can be provided quickly based on providing the requests to a specific set of potential merchants and service providers, with higher relevancy and more personalized content than a normally submitted search request. Instead of visiting multiple locations for answers, such as a merchant's web site, a search engine, and other tools, a user can submit a single, detailed request and receive multiple offers related and responsive to that request. The present disclosure provides a filtered and ranked stream of quality potential business leads for merchants and service providers.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic diagram of an example system that can facilitate connections between users and information sources.

FIG. 2A is a flowchart of an example method for receiving and categorizing requests from users for goods or services and collecting a set of responsive offers from information sources providing the requested goods or services.

FIG. 2B is a flowchart of an example method for analyzing and ranking a set of responses from information sources responsive to a request from a user for goods or services.

FIG. 3 is a flowchart of an example method for submitting a request for goods or services and reviewing a list of one or more responsive offers from the perspective of a client device.

FIG. 4 is a flowchart of an example method for retrieving and responding to requests for goods or services from the perspective of an information source.

### DETAILED DESCRIPTION

In general, a system stores profile information from multiple information sources and uses the stored information to identify appropriate information sources for answering or responding to questions or requests submitted by system users. Further, the system can also store information on system users to better match those system users with particular information sources. The system can provide a mechanism for submitting questions regarding or requests for goods or services via various communication channels (e.g., chat, short message services (SMS), email, social networking, etc.). The submitted questions or requests can then be categorized based on any suitable factors, including geography, industry, and/or subject matter. Once categorized, a plurality of potential information sources (or profiles associated with the information sources) can be reviewed and searched to determine which of the information sources are likely to provide a quality answer or response to the system user. The questions or requests can then be routed to the identified information sources, or alternatively to locations or addresses associated with the identified information sources (e.g., a Really Simple Syndication (RSS) feed). Each of the identified information sources can determine whether or not to respond to the question or request. The responses of the information sources can be collected at a centralized location, and then ranked and filtered according to a plurality of criteria, including, for example, the quality of the response (e.g., based on a keyword or other analysis of the response), a bid associated with the response (e.g., a bid defining the amount paid by the information source for the response to be provided to the user or for other response-related events), profile data associated with the information source (e.g., a general reputation of the information source, the information source's reputation specific to the category of the request, or the quality of previous responses provided by the information source), among others. Once ranked, the set of responses can be provided to the requesting user. The user can choose to interact with or select from one or more of the responding information sources to engage in further transactions associated with the initial request for goods or services. The initial request can be provided as a natural language search request, allowing users to submit requests in a conversational manner with a clear definition of the goods or services being requested. In some instances, users can be specifically associated with a user account within the system. Alternatively, the service can be provided to users not specifically associated with a user account, but who can submit requests via email or SMS message. The service may require both the user and the information source to explicitly opt to participate in the service, with or without an actual user account.

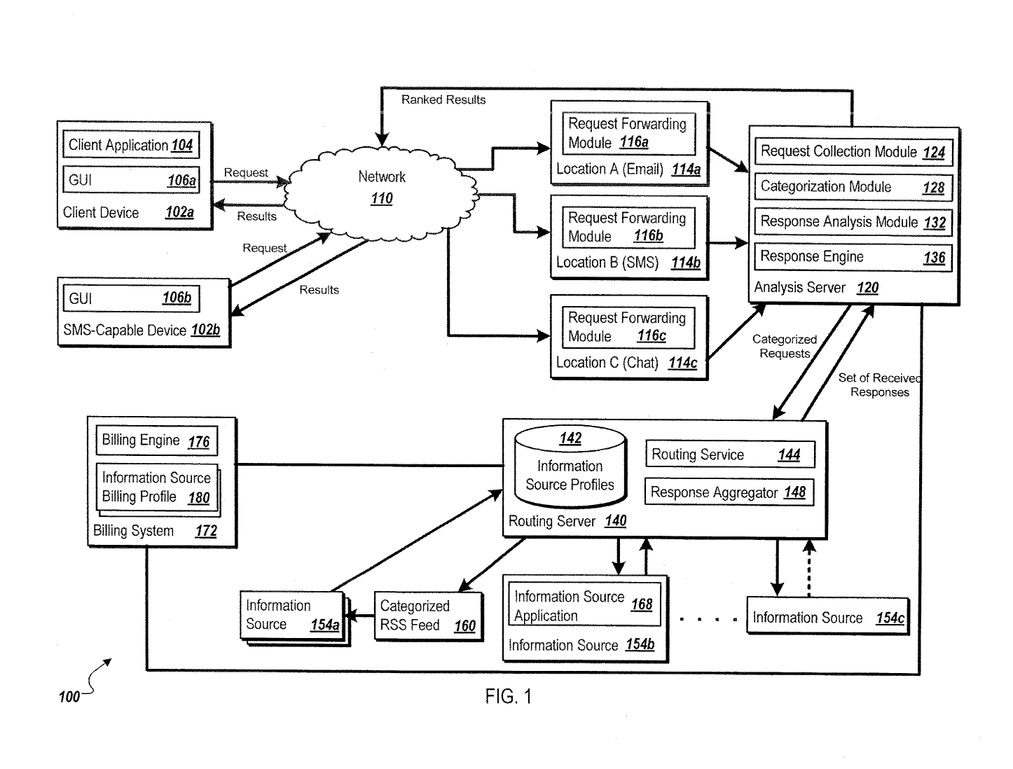

FIG. 1 is a schematic diagram of an example system 100 that can facilitate connections between users and information sources. The illustrated system 100 includes multiple client devices 102, a network 110, a set of locations 114 to which requests are initially sent, an analysis server 120, a routing server 140, and a plurality of information sources 154. Communications throughout system 100 can be performed via the network 110. Additionally, and while not illustrated in FIG. 1, the various other illustrated components can also communicate via network 110 (e.g., location A 114a and analysis server 120, analysis server 120 and routing server 140, and routing server 140 and the various information sources 154). The network 110 can include one or more local area networks (LANs), a wide area network (WAN), a wireless local area network (WLAN) or WiFi network, a Third Generation (3G) or Fourth Generation (4G) mobile telecommunications network, a wireless cellular network, a private network such as an intranet, a public network such as the Internet, or any combination thereof. In general, the client devices 102 communicate with the analysis server 120 (via one or more channels) to submit requests for goods or services to be provided by one or more information sources 154.

Each client device 102 can be any suitable device associated with a user that is capable of submitting requests for goods or services to the system comprising the analysis server 120 and the routing server 140. In some instances, the requests can be submitted via a search engine, a dedicated communication channel (e.g., a particular SMS, email, or chat address), a web-based service or web page, or any other suitable means. The requests can be structured as natural language entries or searches, such that the submitted requests are similar to a regular spoken request. For example, client devices 102 can be mobile devices, such as a mobile phone, a smart phone, (e.g., SMS-capable device 102b), a tablet computer, a netbook, or a laptop. Still further, client devices 102 can be relatively immobile devices, such as a desktop computer or a set-top digital television device, as well as any other suitable type of device. Client devices 102 can include graphical user interfaces 106 to allow users to submit queries and view results on or through the devices. In some instances, the client devices 102 can receive input from touch gestures using a touch screen, input from a keypad or keyboard, or voice instructions, among others, and can process those inputs to generate a corresponding request for delivery to a specified location.

As illustrated, client device 102a includes a client application 104 that can be used to allow the client device 102a to receive, transmit, and view the data associated with a particular request. The client application 104 can be an application dedicated to searches as described herein, or a general purpose application (e.g., a web browser, chat program, or email client application) for accessing various communication tools and technologies, including those that allow users to access web pages and web-based applications, where at least some of those tools and technologies can be associated with submitting requests and viewing responses thereto. Alternatively, client device 102b is illustrated as an SMS-capable device, which can send messages to a particular SMS recipient associated with a request. In some instances, both client devices 102 can be capable of sending SMS messages to an SMS recipient to perform the operations described herein. Additionally, the SMS-capable client device 102b can also be capable of submitting requests via methods other than SMS.

As illustrated, the client devices 102 send the requests provided by their users to a particular channel, address, or location via network 110. As illustrated in FIG. 1, three specific channels are identified, including an email-based location A 114a, an SMS-based location B 114b, and a chat-based location 114c. Although not illustrated in FIG. 1, additional channels can be available via network 110, including a web page or search engine for submitting user requests for goods or services. Each of the locations 114a, 114b, and 114c includes a corresponding request forwarding module 116a, 116b, and 116c. Each request forwarding module 116 can forward the received request to one or more analysis servers 120, where the requests can be further processed. In some instances, each location 114 can be associated with a different analysis server 120. Additionally, each location 114 can be associated with a plurality of different analysis servers 120, with the request forwarding modules 116 performing some initial processing of the requests (e.g., based on the user's geography, the content of the request, or other information) to determine to which analysis server 120 the request will be forwarded. As illustrated in FIG. 1, each request received, regardless of the channel used for submission, is forwarded to the illustrated analysis server 120. In some instances, requests can be sent directly from the client device 102 to the analysis server 120. Although this specification describes receiving communications at different locations, the locations can alternatively represent different modules that receive different types of communications, even if the modules reside on co-located servers or even the same server.

The analysis server 120 receives the request, as well as any additional information sent by the user, client device 102, or derived by the respective request forwarding modules 116. In some instances, the submitted request and the identity of the submitting user or client device 102 is the only information received by the analysis server 120. In other instances, information associated with a client device or user profile can also be received by or available to the analysis server. In some instances, information on the submitting client device or user can be used in the various analyses performed by the analysis server 120, such as to provide additional information for categorizing requests and determining which information sources can be best suited to provide responses.

As illustrated in FIG. 1, the analysis server 120 includes four components: a request collection module 124, a categorization module 128, a response analysis module 132, and a response engine 136. In some instances, the analysis server 120 can include one component combining the functionality of each illustrated component, while in other instances, the analysis server 120 can include additional components performing some or all of the functionality associated with the four components, as well as other functionality associated with or distinct from the present disclosure. The request collection module 124 provides a service for collecting various requests received from the one or more locations or channels 114, and placing those requests in an appropriate queue or list. In some instances, a plurality of requests for goods or services may be processed concurrently by the analysis server 120, while in others, only a single request (or other finite number) may be processed at once. The request collection module 124 can perform the operations associated with determining when and how to process the set of received requests.

The categorization module 128 analyzes the received request to generate or derive categorization information from the request. In the present example, the categorization module 128 may parse and analyze a received request to provide a geographical and/or vertical categorization of the request. Additionally, information associated with the client device 102 and/or its user may also be used for categorization purposes. Requests may be submitted in free text or natural language form to the system, allowing for all of the requirements of the service to be specified in a single search or request entry. In some instances, users may add specific information to the request in order to more clearly specify a particular categorization of the request. For example, the request may include a hash tag (i.e., “#leisure” or “#Sonoma”) to explicitly indicate a particular categorization associated with the search. The categorization module 128 may be associated with a classification system or taxonomy, providing a basis for matching key words and context information associated with a request to a particular category. Additionally, the categorization module 128 may dynamically identify additional categories based on request and response analysis performed within the system. In some instances, dynamically identifying additional categories may include determining categories without user input, by recognizing patterns in requests and responses through the system. In one example, the categorization module 128 can, based on a threshold of uses of a particular unique or common phrase, add a category corresponding to the unique or common phrase. Those additional categories may be added to the categorization system or taxonomy and used for later received requests. In some instances, multiple categories may be associated with a single request. When later identifying information sources, some or all of the categories associated with the request may be considered.

An example submission may be a request for an available hotel booking for a particular weekend in Sonoma, Calif., with a spa available on-site at the hotel. The categorization module 128, as described above, may analyze the received request to automatically determine that the geographic categorization of the request is Sonoma, Calif., while the industry or vertical categorization of the request may be leisure, hotels, or any other suitable category (e.g., as derived from keywords included in the request in light using a reference to a classification system.) In the illustrated example of FIG. 1, once the request is categorized, the categorized request is provided to the routing server 140 to determine which information sources 154 may be in the best position to answer or respond to the request.

The response analysis module 132 of the analysis server 120 receives a set of responses to the categorized request from the routing server 140 (as described below). The response analysis module 132 can analyze, rank, and filter the received responses received at the routing server 140 based on any suitable criteria, including the quality of the responses, the information sources associated with each response (e.g., a reputation of the information source based on previous interaction within the system, the expertise of that information source associated with a particular categorization, etc.), and a bid associated with the response (e.g., the price a particular information source may be willing to pay to present its response to the user). Based on the criteria used to analyze the received responses, the analysis server 120 can filter out poor responses while also determining a relative ranking of the acceptable responses.

The response engine 136 receives and/or collects the set of ranked responses from the response analysis module 132 and generates one or more messages to be returned to the user or client device 102 that submitted the request. In some instances, the style and format of the responsive message may differ based on the incoming channel through which the request was received, or through which the responsive message is to be sent. For example, if a request is initially received via SMS, the responsive message may be formatted for a return message sent via SMS. In some cases, formatting the responsive message may require multiple messages to be returned, or alternatively, for the responsive message to send only a subset of the ranked responses back to the client device 102. In the SMS example, the responsive message may be limited to set number of characters. In some instances, only the top-ranked response may be returned in the responsive message to the client device 102. In those instances, a hyperlink may be provided to allow the user to navigate to a listing of additional, lower-ranked responses. Similar modifications and message formatting may be performed when the initial message was received via email, chat, a website, or any other available channel. Further, the responsive message may be returned via a different channel than that in which the initial request was provided. In some instances, the method of providing the responsive message may be determined based on a user or client device profile accessible to the response engine 136. In other instances, the responsive message may be returned to a different client device 102 than the client device 102 that submitted the request. The responsive message containing one or more of the ranked responses may be presented at the client device 102 via the client device's respective GUI 106, as well as through usage of a client application 104 available at the client device 102.

As described above, the routing server 140 receives the categorized requests from the analysis server 120 (via the categorization module 128) and can determine which information sources 154 should be provided with the opportunity to respond to the request. As illustrated in FIG. 1, the routing server 140 includes a repository of information source profiles 142, a routing service 144, and a response aggregator 148. The repository of information source profiles 142 can include information on a plurality of information sources 154 registered with or known by the system. The information source profiles 142 may be accessible to the analysis server 120 as well as the routing server 140, and, in some instances, may be located remotely from the routing server 140. Each of the information source profiles 142 may include information defining the categories of information associated with each particular information source 154 within system 100. Additionally, the information source profiles 142 can include information defining where and how a particular information source may be contacted. In some instances, the contact information for a particular information source 154 may be a designated individual representative of an organization represented by the information source 154. For example, the email address or chat-related user name of a customer representative associated with the information source 154 may be identified by the information source profile 142. Alternatively, an RSS feed or another location with which the information source 154 is associated may be identified as the contact information or address for that information source. In such instances, the information source 154 may subscribe to certain RSS feeds (or other messaging solutions, including a Twitter feed or other social networking site), where a representative of the information source 154 can monitor request submissions and determine whether or not to respond with an offer to the request.

In addition to the categories of information associated with a particular information source 154 and the information source's contact information, the information source profiles 154 may also include information providing or representing metrics on the quality of responses previously provided by a particular information source 154 within the system 100, as well as a reputation of the particular information source 154 (e.g., based on prior interactions within the system), which may include an overall reputation of the particular information source 154, as well as a one or more category-specific reputations of the particular information source 154. These reputation values, as well as prior quality of responses, can be used when determining the relative rank of an information source's response, allowing the system to predict which information sources 154 are more likely to provide useful and positive responses to requests, and ranking those responses accordingly via the response analysis module 132 of the analysis server.

The routing service 144 determines, based on the categorizations of a particular request by the analysis server 120 and an analysis of the repository of information source profiles 142, which information sources 154 will be provided with the opportunity to respond to the submitted request, as well as how to transmit the request to those information sources 154. Once contact information for each of the information sources 154 that match or satisfy the categorization of the request (provided by the analysis server 120) is determined by the routing service 144, the request, or information derived from request, is sent to the identified information sources 154 based on the identified contact information. In some instances, the contact information within the information source profiles 154 may designate a particular messaging protocol or message type to be used to transmit the requests. In those instances, the routing service 144 can modify the submitted request to the appropriate message type (e.g., XML, email, SMS, etc.), and send the message to the information source using the designated messaging protocol. In some instances, the routing service 144 (and/or routing server 140) may include interfaces for various types of communications as specified by the information source profiles 142. In some instances, the contact information associated with a particular information source 154 may be associated with an RSS feed, or other location where messages are not sent directly to the information source 154 itself. In those instances, the message can be sent to the RSS feed or other location monitored by the information source 154, and, upon identifying a message of interest, retrieve the message. The message may include correspondence or other forwarding information providing the retrieving information source 154 with instructions or details on where and how to provide responses and/or offers. In other instances, the routing service 144 may identify one or more categorized RSS feeds 160 or other locations based on the categorized request, and send the corresponding message to those locations. Information sources 154 associated with the location, without being specifically identified by the routing service 144, can then retrieve and respond to the request.

As illustrated in FIG. 1 and as described above, the system 100 may be associated with a plurality of information sources 154. Each information source 154 may correspond to, represent, or be associated with a merchant, service provider, or expert associated with a particular category or type of goods and/or services. In some instances, each information source 154 may register with the routing server 140 or other appropriate portion of the system 100 in order to be considered as a potential match for a submitted user request. In other instances, information associated with some information sources 154 may be derived and/or imported from other systems, such as by generating new information source profiles 142 associated with those imported information sources 154. Each information source 154 may be associated with a particular contact address or location identifying to where requests sent by the routing service 144 are to be directed. In some instances, the contact address or location may be an email or chat address for a particular user associated with the information source 154, while in other instances, the contact address or location may be associated with an information source-specific incoming address for all requests, with multiple users or representatives associated with the information source 154 able to access and respond to received or identified requests.

In FIG. 1, three methods for sending requests to information sources 154 are illustrated. In the first, the routing service 144 identifies one or more information sources 154a as being relevant to a request, and sends the request to a categorized RSS feed 160 associated with those identified information sources 154a. One or more information sources 154a are associated with RSS feed 160, and can access, retrieve, and respond to the requests as they are collected or received at the RSS feed 160. The requests provided to and included in the RSS 160 can include responding address information associated with the routing server 140, or any other location associated with the routing server 140 and its functionality, such that any information source 154a responding to a request from the RSS feed 160 can identify the correct location to which to address the response. The second illustrated method of providing requests to an information source 154 is illustrated by the connection of the routing server 140 to the second information source 154b. The second information source 154b includes an information source application 168 associated with the illustrated system 100, through which one or more requests and their associated messages can be delivered to the information source 154b. In some instances, the information source application 168 can be an application specific to receiving and responding to requests from users of system 100, while in other instances, information source application 168 can be a general purpose application (e.g., a web browser) that can be used to access one or more web-based or remote programs or applications (e.g., an email client, a chat program, a social networking application or site, etc.) to where the requests may be sent, and through which responses thereto may be generated and submitted. The third illustrated method of providing requests is illustrated with information source 154c. Requests are forwarded directly to the third information source 154c via email, direct messaging, or any other suitable method, allowing the user associated with the information source 154c to choose whether or not to respond to the request. As illustrated by the dotted line between the third information source 154c and the routing server 140, each information source 154c (and/or its associated user or representative) may select whether or not to respond to a particular request. In some instances, a particular information source 154 may not provide a response to a request for any number of reasons, including whether the request includes goods or services which the information source 154 can actually provide according to the parameters included within the request.

The responses received from the one or more information sources 154 may be received at the routing server 140, or at any other location capable of providing similar functionality. In some instances, the routing server 140 may route the requests to information sources 154, while another component receives and collects the corresponding responses. The routing server 140 and routing service 144 can include specific addresses for responses to be sent with the messages including the user's request sent to the information sources 154. In the illustrated system 100, responses are directed back to the routing server 140. The routing server 140 includes a response aggregator 148 for receiving, identifying, and aggregating the responses received from the one or more responding information sources 154, as well as forwarding those aggregated responses to the analysis server 120 for further consideration, analysis, ranking, and filtering. In some instances, the routing server 140 can perform some or all of the response analysis functionality performed in the illustrated system 100 by the response analysis module 132. In other instances, the routing server 140 can perform an initial filtering of the received responses, while the response analysis module 132 can perform additional and/or advanced filtering and ranking functions. As described above, the response analysis module 132 filters and ranks the set of responses received from the information sources 154, and the response engine 136 generates the appropriate response to be sent back to the requesting client device 102.

Further illustrated in FIG. 1, a billing system 172 may be incorporated into system 100. The billing system 172 includes a billing engine 176 and a set of information source billing profiles 180. In some instances, the billing system 172 may provide information to either or both the analysis server 120 and the routing server 140. The information from the billing system 172 can be used, at least in part, to filter and rank responses received from one or more information sources 154, as well as to determine which information sources 154 may receive a particular request for goods or services. As illustrated, the billing system 172 includes a set of information source billing profiles 180. In some instances, the information source billing profiles 180 may be integrated or included with the information source profiles 142 of the routing server 140. The information source billing profiles 180 can provide information to the billing system 172 and the other components with regard to bids provided by different information sources 154 to be paid or debited in response to a particular event within the illustrated system 100. For example, each information source 154 can submit bid values for different events within the illustrated system 100, including an amount to be paid for receiving a particular request and/or an amount to be paid for providing a particular response to the requesting client. In some instances, an information source 154 can submit different bid values for receiving, responding to, presenting responses to a user, and/or initiating a transaction with a user for different categories or types of requests. Components within the system 100 can weigh the bid values as part of the filtering and ranking system, such as by combining metrics determining a quality or quality score of a particular response along with the bid value submitted by the responding information source 154. By combining those values, the relative quality can be considered along with the submitted bid value to determine how and which responses will be provided in response to a request. For example, a first bid may be submitted by an information source representing a hotel in northern California for when requests are categorized as Leisure in Northern California. The hotel may also submit a second, lower bid for when requests are categorized as Leisure in Central Calif. Because the hotel is primarily providing goods and services in northern California, the first bid is higher than the second bid, providing a higher likelihood for responses from the hotel to be provided to end users where the categorization is Leisure in Northern California. In general, a response from a second information source 154 which submitted a lower bid than the first bid of the hotel will be ranked lower in the set of responses than the hotel's if the combination of the quality of the hotel's response and the first bid is higher than the combination of the second information source's response quality and corresponding bid value. The information associated with each type of bid provided by various information sources 154 can be stored in a corresponding record within the set of information source billing profiles 180. The billing engine 176 can be used to identify the appropriate bid and bid value in response to a particular action or event, as well as to determine, after the action or event has occurred, how much to charge a particular information source 154.

An alternative method of billing that may be used in system 100 can be based on lead generation, as well as the quality of a particular lead generation. When a response is provided to a particular user or client device, the likelihood of a lead actually being generated from that response may be calculated. The factors of that calculation may include a user profile associated with the user of the client device 102 providing information on how likely the user is to create a relationship between the merchant or service provider associated with the information source 154, as well as based on where the response and/or offer from the information source 154 is ranked and provided within the responsive message. In some instances, charges for responses may only be issued if the user or client device 102 views a particular response within the message, or if the user or client device 102 actually initiates a relationship with the information source 154 in response to receiving the message. In some implementations, the billing engine 176 may perform functionality associated with identifying whether a relationship or interaction between the client and information source 154 is created in response to the message. In some instances, a hyperlink or other method of tracking the user's actions may be included within the responsive message by the response engine 136, such that the activation of a link or interaction can be tracked by the billing engine 176 or the billing system 172. When a successful interaction is received, the billing engine 176 can calculate the amount to be charged or debited from the information source 154, while the metrics associated with the information source 154 can be updated. For example, if a particular information source's response is selected, the set of information source profiles 142 may be updated to increase the reputation or ranking of the selected information source 154, so that in future interactions, the selected information source 154 may be ranked higher based on its previous successes. This feedback allows the system 100 to adapt to changing market and response conditions, so that those entities that provide better, or more often used, responses are provided relatively higher rankings and reputation scores moving forward. Similarly, if a particular information source 154 is not selected, its reputation score may be decreased such that future rankings may reflect the non-selection of the information source's 154 responses and offerings.

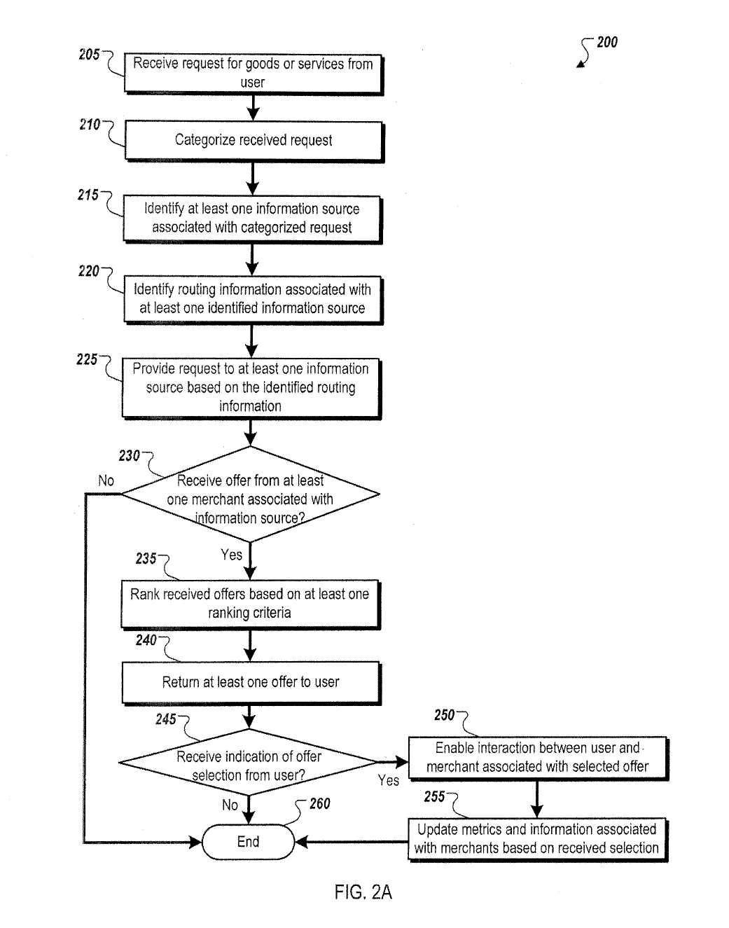

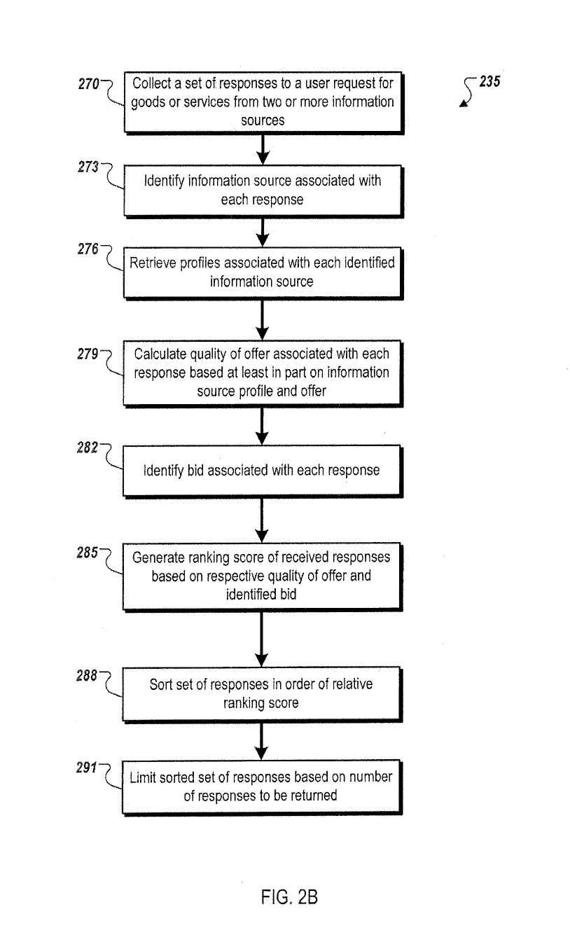

FIG. 2A is a flowchart of an example method 200 for receiving and categorizing requests from users for goods or services and collecting a set of responsive offers from information sources providing the requested goods or services. For clarity of presentation, the description that follows generally describes method 200 in the context of system 100 illustrated in FIG. 1. However, it will be understood that method 200 may be performed, for example, by another system, environment, or combination of systems and environments.

At 205, a request for goods or services is received from a user. The request for goods or services may be received via any suitable channel, including, but not limited to, email, chat messaging, social networking, SMS, MMS, or a dedicated web-based service or site. For example, the received request may be received via a dedicated request pipeline or address, such as a particular email address (e.g., wanted@answermyquestion.com), a particular SMS short code, a known chat bot, or a web-based entry form. In some instances, the request can be received in free text format, a natural language format, or a Boolean format. Additionally, the received request may be formatted in complete sentences, sentence fragments, or based on one or more keywords and information.

At 210, the received request is categorized. Categorizing the received request may include parsing and analyzing the received request to identify one or more key words or phrases included therein. Those key words or phrases can be used to identify a geographical location associated with the request (e.g., a particular city, state, or region, etc.), a particular vertical categorization of the goods or services requested (e.g., industry, types of goods or services, etc.), or any other suitable categorizing identification. In some instances, information associated with the requesting user, such as the user's geographical location, previous searches, or interests may be used to assist in categorizing a particular request. Other information, including trending topics and recent categorizations of other requests, may also be used in categorizing a particular request. It will be understood that any suitable signals or information can be used to categorize a request, and further, that a single request may be associated with more than one categorization. Additional filtering and categorization may be performed to further categorize requests using behavioral or demographic information associated with the request and/or the requestor. In some instances, the request can be anonymized to remove some or all of the user-specific information from the request. Further, a set of predefined categories may be available, such as through a classification system or taxonomy. The classification system or taxonomy may be modified to add new categories as additional requests and responses are received, as well as when new information sources are identified, allowing the system to evolve with the requests and information sources associated therewith.

At 215, at least one information source associated with a categorized request is identified. Information sources can include specific entities, businesses, experts, and/or individuals likely to offer or provide the requested goods or services. In some instances, information sources can be registered with a particular system in order to provide or generate a profile associated with the information source. The information source profile can provide information on which categories a particular information source may be associated. In some instances, the information source profiles can designate geographical regions in which goods or services can be provided by a particular information source, as well as the type of goods or services that can be provided. In some instances, the information source profiles may include information derived from one or more interactions within the system, such as additional categories to be associated with a particular information source.

At 220, routing information associated with the at least one identified information source is identified. The routing information can be included within the profile associated with an identified information source, or can be retrieved from any other suitable location or source. In some instances, the routing information can include a specific method of communication for an identified information source, and can be included within a profile associated with the identified information source. In some instances, the identified set of information sources associated with the categorized request may be associated with different contact addresses and locations, as well as different communication protocols and channels through which the request is to be sent. For example, a first information source associated with a categorized request may be associated with a specific email or chat address, while a second information source may be associated with an RSS feed where requests are to be sent, and from where the second information source can access the categorized request. In some instances, the information source itself may be an RSS feed corresponding to at least one of the categorizations of the request, where the RSS feed is associated with a plurality of merchants and service providers. By providing the request to the categorized RSS feed, one or more of the plurality of merchants or service providers can respond to the request. Other types of contact addresses, protocols, and channels may be included with the identified routing information.

At 225, the request is provided to at least one of the identified information sources based on the identified routing information. In some instances, this may include forwarding the received request through multiple channels, including sending an email to a contact or correspondence address associated with a first identified information source, sending a chat message sent via chat messaging protocol and/or a chat message program to a particular user or chat bot associated with a second identified information source, and sending an XML document including the received request for addition to a categorized RSS feed associated with a third identified information source, among others. In some instances, a particular component or application can format the received request into the appropriate message format according to or based on the identified routing information of each information source. In FIG. 1, the component performing this functionality is the routing service 144, although any suitable component or application can be used.

At 230, a determination is made as to whether a responsive offer is received from at least one merchant or service provider associated with one or more of the identified information sources. If at least one offer is received, method 200 continues at 235. If no offers are received, method 200 ends at 260. Offers from merchants and service providers can be received at one or more locations. In some instances, the request provided to the identified information sources may include a specific location at which responses can be sent. In some instances, the identified information source can respond directly to the forwarded request using the same channel or communication protocol through which the forwarded request was received (e.g., via a reply email or chat). In some instances, each forwarded request can include an information source-specific response location or ID that can be used, once the responses and offers are received, to identify which information source or set of information sources provided the corresponding offer. The responses and offers (or references thereto) can be aggregated, collected, and/or managed at a single location.

At 235, the received responses and offers are ranked in relation to each other based on at least one ranking criteria. The at least one ranking criteria may include one or more of the following: the quality of the match of the offer to the request, the previous history or reputation of the merchant or service provider submitting the offer or response, a successful history or previous interactions between the requestor and the merchant or service provider (or other users associated with the requestor), and the location of the merchant or service provider, as well as any other suitable signal or criteria. In some instances, the ranking and analysis can provide each response with a corresponding quality score to be used when comparing two or more responses or offers. Alternatively, a predicted click-through probability can be generated for each response to determine which of the responses or offers are most likely to be accepted or reviewed by the requesting user. In some instances, a bid value or amount submitted by the responding merchant or service provider may be considered when ranking offers or responses. The bid value or amount can represent a value associated with a particular action or event, such as a bid for sending a submitted offer to the requesting user or a bid for initiating an interaction between the merchant or service provider and the requesting user. The bid value may be combined with the quality score of a particular response or offer to generate a combined score or relative rating of a particular response.

At 240, at least one of the offers or responses received in response to the request is returned to the requesting user. Responses from multiple merchants or service providers can be combined into one or more messages and returned to the user. In some instances, the messages returned to the requesting user may be sent using the same message format in which the original request of 205 was received. For example, if the user submitted the original request via email, then the responsive message can be returned via email. If the original request was sent via SMS, the responsive message can be returned via SMS. Alternatively, the responsive message can be returned in a different message format than that of the original request. In some instances, the message format of the responsive message may be determined by information received from the user, or information associated with a profile of the user. In some instances, the user may specify that all responsive messages be returned via email, regardless of the format of the original message. In other instances, the original message may include information specifying how the responsive message is to be sent. Depending on the message format of the responsive message, one or more offers or responses are returned to the requesting user. If the responsive message is to be sent via SMS, fewer offers may be returned in a single responsive message, and multiple responsive messages may be sent.

In some instances, only a subset of offers or responses received at 230 may be returned to the requesting user. For example, the quality score of a response may be required to meet a threshold score or value before it will be returned to the requesting user. In such cases, the threshold score may represent a value determined to separate helpful responses from unhelpful or insufficient messages, allowing the system to filter out poor responses prior to sending the responsive message to the requesting user. Additionally, the number of offers or responses returned to the user may be limited based on a specified user preference, the message format, or based on a determination of the suitable number of responses to be included in the responsive message(s) that will provide an adequate number responses to the requesting user without providing too much information for the requesting user to process.

At 245 a determination is made as to whether an indication that an offer or response returned to the user is selected. An indication that an offer or response is selected may include the activation of a hyperlink included in the responsive message, the user visiting a specific web address included in the responsive message, or any other interaction indicating that a particular offer or response has been selected by the requesting user. If none of the offers or responses are selected, method 200 ends at 260. Where no offer is selected, and instead of ending the method 200, an additional set of responses may be returned to the requesting user, including one or more responses or offers not included in those returned to the user at 240, or by soliciting additional responses from one or more information sources and their associated merchants or service providers. Where an indication that an offer or response has been selected is received, method 200 continues at 250.

At 250, interaction between the requesting user and the merchant or service provider associated with the selected offer or response is enabled. In some instances, enabling the interaction may comprise providing a hyperlink to the merchant or service provider's website with the responsive message, so that the requesting user can navigate directly to a page or application for furthering the relationship between the parties. Alternatively, a centralized location may be provided within the system that allows the requesting user and the merchant or service provider associated with the selected offer to interact at third-party location. Still further, any other appropriate means of enabling further interaction between the user and the merchant or service provider associated with the selected offer can be used at 250.

At 255, metrics, information, and/or a profile associated with the merchants or service providers associated with the original request can be updated. For example, information associated with the selected merchant or service provider can be updated to indicate a successful interaction within the system that can be used in later iterations of method 200, such as during the ranking operations of 235. Conversely, information associated with the non-selected merchants or service providers can be updated to reflect the non-selection of those entities in response to the offers. Still further, the fact that certain merchants or service providers did or did not respond to an offer can be updated for future determinations of which information sources are associated with a particular request. Any suitable information or metrics can be updated according to the interactions of the various entities in method 200, allowing the actions to be fed back into the system and used in future iterations of the method 200, thereby increasing the reliability and performance of the method and system over time.

FIG. 2B is a flowchart of an example method for analyzing and ranking a set of responses from information sources responsive to a request from a user for goods or services. Specifically, FIG. 2B provides one example implementation of a sub-process associated with operation 235 of FIG. 2A. At 270, a set of responses and offers from two or more information sources (i.e., the merchants or service providers associated therewith) to the original user request (e.g., received at 205 of FIG. 2A) is received.

At 273, the information source associated with each response or offer is identified. In some instances, the identification may be performed based on a comparison of a unique ID included with the forwarded request when sent to each of the identified information sources, and a unique ID included with each response or offer. In other instances, information may be derived from the received response or offer that can be used to identify a particular information source, merchant, or service provider. Once the particular information sources, merchants, or service providers associated with each response or offer are identified, profiles associated with each of the identified information sources are retrieved at 276. The profiles may include information associated with previous interactions of an identified information source, the expertise in a particular category of the identified information source, information associated with the overall or category-specific reputation of the identified information source, as well as other suitable information providing additional context regarding the information source.

At 279, a score representing the quality of each response or offer is calculated based, at least in part, on an analysis of the offer or response and information retrieved from the profile associated with the information source, merchant, or service provider from where the response or offer is received. For example, a key word analysis of the response or offer in light of the original request may be performed to determine whether the response or offer is responsive to the original request, with that determination being combined with one or more metrics associated with or stored in the profile corresponding with the source of that response or offer. In alternative implementations, different combinations may be used to perform the analysis. Additionally, only the calculated quality score of the responses or offers may be considered in some instances. Further, a bid value associated with each response is identified at 282. The various bid values may be associated with the same events (i.e., for providing the response to the requesting user), or the bid values may be associated with different events (i.e., bid 1 is associated with providing the response to the requesting user, while bid 2 is associated with the user's acceptance of the offer or response provided). At 285, a ranking score of each of the received responses is generated based on a combination of the calculated quality of response or offer and the bid value associated with those offers. In some instances, different weights may be applied to the quality score and the bid value according to the settings and parameters of the specific system. Once the ranking scores for each of the responses or offers are generated, the set of responses or offers can be sorted by their relative ranking scores at 288 to generate a sorted, ranked set of responses or offers. In some instances, the relative ranking scores may be further sorted or filtered based on additional criteria or determinations. At 291, the sorted set of responses may be limited or filtered based on the number of responses or offers to be returned to the requesting user. For example, if only ten responses are to be returned, only the top ten responses in the sorted set will be retained or included in the set of responses to be provided to the user. In some instances, the other responses may be stored in case none of the top ten responses is selected by the user.

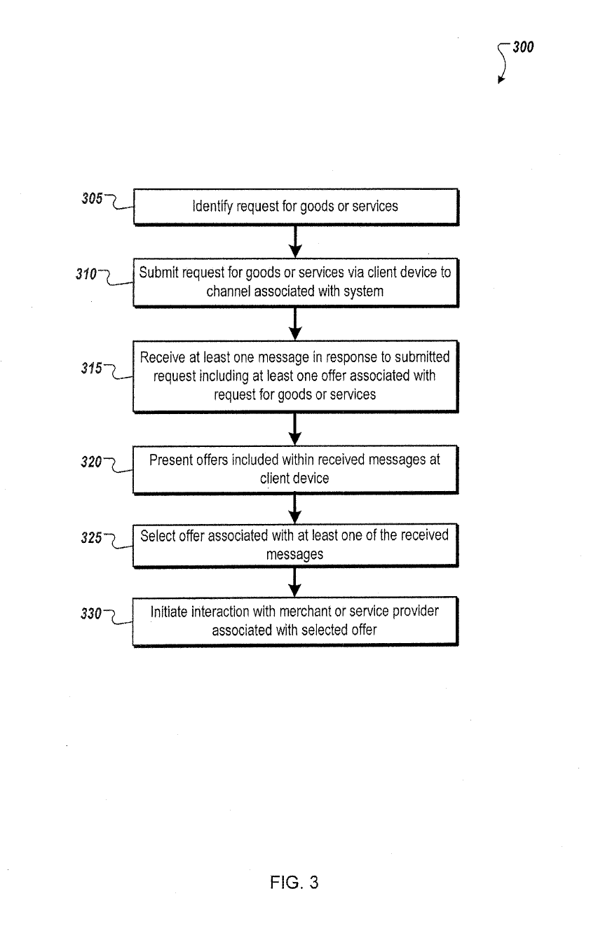

FIG. 3 is a flowchart of an example method for submitting a request for goods or services and reviewing a list of one or more responsive offers from the perspective of a client device. For clarity of presentation, the description that follows generally describes method 300 in the context of system 100 illustrated in FIG. 1. However, it will be understood that method 300 may be performed, for example, by another system, environment, or combination of systems and environments.

At 305, a request for goods or services is identified by the client device. In some instances, the request may be entered by a user associated with the client device by entering the request in natural language form, such as by the following example request: “Which hotel can I stay at between October 1^{st} and October 3^{rd} in Sonoma, Calif., that has a spa?” At 310 the request is submitted, via the client device, to a channel associated with the request and response system. The channel through which the request is submitted can be selected by the user, or determined by an application or program included on the client device. For example, the channel may be defined by a specific email address, chat bot address, or SMS short code known to be associated with the request and response system. In those instances, the request can be submitted by email, chat program, or by SMS or text message via the client device. Alternatively, the user may use the client device to access a particular web-based front-end or page associated with the request and response system, using a search engine-like entry to submit a request.

At 315, at least one message including at least one offer or response in response to and associated with the submitted request is received at the client device. In some instances, the message can be received via the same channel through which the request was submitted at 310. For example, if the request was submitted via email, a responsive email message may be received. Similarly, if the request was submitted via SMS, a responsive SMS message may be received. Alternatively, the at least one responsive message may be received by a different channel than which the original request was submitted. In some instances, the user can specify the channel through which the responsive messages are to be received in the original request. In some instances, multiple responsive messages may be received at the client device.

At 320, the responses and offers included within the responsive messages are presented at the client device, such as through a GUI associated with the client device. The user can review the responses and offers included in the at least one message, and can select a particular response or offer presented in the message at 325. Once the response or offer is selected, the contents of the message can be used to initiate interaction between the user of the client device and the merchant or service provider associated with the selected response or offer at 330. In some instances, the interaction may be performed by sending and receiving additional messages via the client device and the merchant or service provider through the same channel in which the responsive message was received. In other instances, the interaction may be performed via a different channel than in which the responsive message was received. In some instances, the interaction may be performed using different functionality of the client device, including by calling a phone number for the selected merchant or service provider embedded or included within the message to initiate a phone-based interaction between the user and the selected entity.

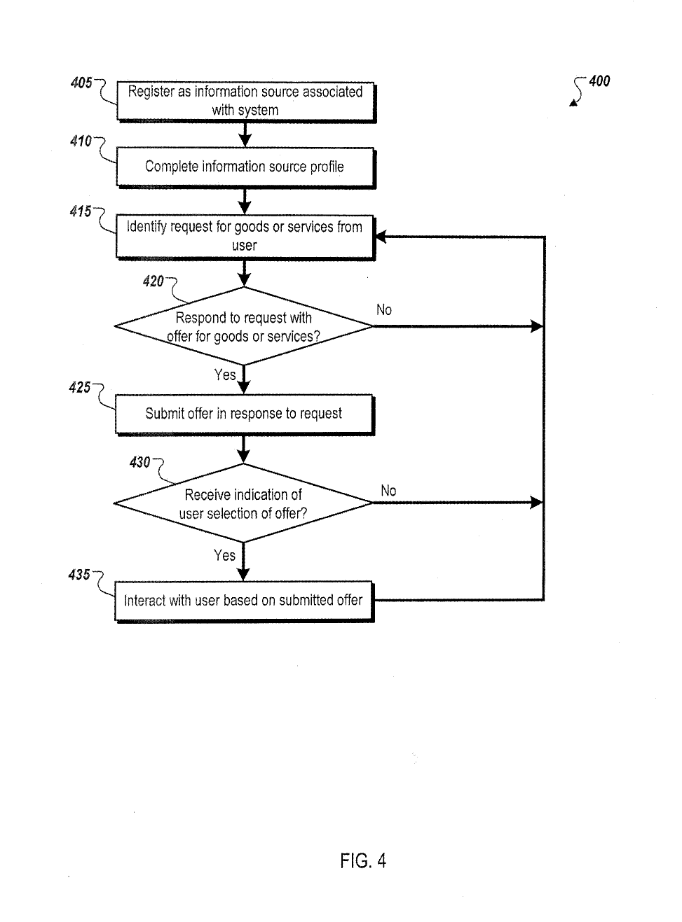

FIG. 4 is a flowchart of an example method for retrieving and responding to requests for goods or services from the perspective of an information source. For clarity of presentation, the description that follows generally describes method 400 in the context of system 100 illustrated in FIG. 1. However, it will be understood that method 400 may be performed, for example, by another system, environment, or combination of systems and environments.

As described above, the information source may correspond to a merchant or service provider. At 405, the merchant or service provider can register as an information source associated with the underlying system. Once registered, the merchant or service provider can complete an information source profile at 410. The information source profile can be used by the system to determine which categories a particular information source, here the merchant or service provider, is associated with, as well as to provide routing and contact information defining how the particular information source can be provided with a specific request. The information source profile can allow the merchant or service provider to define an initial set of categories for which the merchant or service provider would like to receive and respond to requests. In some instances, categorization information can be derived from other information included within the profile, such as where a merchant or service provider has locations and can provide certain goods and services. In some instances, a specific business address of the merchant or service provider can be used to identify and define a geographical area associated with the merchant or service provider. Goods and services information can be included in the information source profile to determine the categories of goods and services offered by the merchant or service provider. Further, goods and services related to those identified by the merchant or service provider can be included within the information source profile for additional searches. When generating the information source profile, the merchant or service provider may be presented with information from a classification system or taxonomy in order to allow system-specific categories to be associated with the profile. In some instances, the merchant or service provider can identify one or more new categories to be added to the classification system or taxonomy.

At 415, the merchant or service provider identifies a request for goods or services from a user. In some instances, identifying the request can include receiving a message from a centralized system forwarding the message to the routing address specified in the information source profile associated with the merchant or service provider. In other instances, the merchant or service provider can monitor a repository or location for newly submitted requests, such as an RSS feed for a category associated with the merchant or service provider.

At 420, the merchant or service provider determines whether to respond to the user's request for goods or services with a response or offer related to the request. If the merchant or service provider does not elect to submit a response or offer, method 400 returns to 415, where a new request for goods or services can be identified. However, if the merchant or service provider decides to respond to the identified request, method 400 continues at 425. The decision to respond to a particular request for goods and services may be based on the merchant or service provider's availability, locality, an analysis of the requesting party (e.g., Has the requesting user completed transactions using the system before?; Is the requesting user likely to accept the available offers the merchant or service provider can respond with?, etc.), as well as any other relevant factors as determined by the merchant or service provider.

Once the merchant or service provider decides to respond to the request for goods or services, the merchant or service provider prepares and submits a response to the identified request at 425. In some instances, the response can include an offer of specific goods or services for a specific price. The response can also include a description of the responding merchant or service provider and its available goods and/or services, a description of those goods or services, and an offer or suggestion for goods or services different than, but related to, the requested goods or services. In some instances, the response can also include information on the pricing of particular goods or services, advertisements or literature on particular goods or services, as well as an offer of a coupon or discount for selecting the offer. In some instances, the responses may also include previous recommendations of the merchant or service provider offering the goods or services. In some instances, at least a portion of the response and/or offer can be automatically generated, such as by inserting product information, discounts, and coupons into the offer once a particular good or service is selected for the response.

The response and offer can be submitted in any suitable manner. In one instance, the merchant or service provider can send the response through the channel in which the original request was received. The request can be sent to a specific address or location indicated in the offer identified in 415. In some instances, the responsive offer can be submitted by responding to an email or chat message through which the request was received. If the request was identified from a repository such as an RSS feed, the request may include a specific address or location to which offers should be sent. This may include an email address, a chat address, a website or web-based interface, or any other suitable location. In some instances, the merchant or service provider can access a locally or remotely executed software application through which requests can be identified and through which offers and responses can be submitted. In some instances, the application can be web-based and accessed through a web browser by a representative of the merchant or service provider.

Once the response and/or offer are submitted at 425, at 430 the merchant or service provider determines whether an indication is received that the requesting user has selected the merchant's or service provider's submitted response and/or offer. In some instances, the received indication can be received by a message activated when the requesting user activates a hyperlink or other UI element associated with the merchant's or service provider's response. In other instances, the requesting user may contact the merchant or service provider directly based on contact information included in the response. In other instances, the underlying system may provide a web-based environment where requesting users and responders, such as the merchant or service provider described herein, can interact once the requesting user has selected a particular offer. In some instances, the indication can include an action from the requesting user outside the system, such as a phone call or direct communication based on the contact information included in the response. If no indication that the user has selected the submitted offer is received, method 400 returns to 415 where another request for goods or services from the same or a different user can be identified. In some instances, the determination may be made after a predetermined period of time has passed or after an indication that a response or offer from another merchant or service provider has been selected. If, however, the submitted response and offer are determined to be selected by the requesting user, method 400 continues at 435. At 435, the merchant or service provider can interact with the requesting user based on the submitted response or offer. The interaction at 435 may result in a transaction or business relationship being entered into between the merchant or service provider and the user. In some instances, the system through which requests are received and responses are submitted may provide means to allow the parties to communicate and interact with each other once a response is selected.

While the present disclosure uses a plurality of flowcharts and accompanying descriptions to illustrate the example techniques associated with various methods of FIGS. 2A-B, 3, and 4, system 100 contemplates using or implementing any suitable technique or method for performing these and other tasks. It will be understood that these techniques are for illustration purposes only and that the described or similar techniques may be performed at any appropriate time, including concurrently, individually, or in combination. In addition, many of the steps in these flowcharts may take place simultaneously, concurrently, and/or in different orders than as shown and described. Moreover, system 100 may use processes and methods with additional, fewer, and/or different steps, so long as the processes and methods remain appropriate.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them, where some or more may be non-transitory. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices). In some instances, the computer readable medium can be a non-transitory and/or tangible computer readable medium.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, application, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server. Further, the computing system can include actions performed via a cloud-based computing system implementing a cloud architecture. A cloud architecture may include multiple cloud components communicating with each other through application programming interfaces (APIs), such as web services. A front end of the system may be presented to clients, and may include the client's network or computer, as well as the applications used to access the cloud-based computing system, such as a web browser. The back end of the cloud-based computing system may include various different computers, servers, and data storage devices performing the operations associated with the system.

While this specification contains many specific implementation details, these should not be construed as limitations on the scope of what may be claimed, but rather as descriptions of features specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
storing profile information associated with a plurality of information sources, each information source associated with at least one category;
analyzing, by operation of a computer processor, a request for information from a user where the request includes information associated with at least one good or service sought determining, by operation of a computer processor, one or more information sources as responsive to the request based at least in part on a comparison of the information associated with the at least one good or service sought and the at least one category associated with each information source, wherein information sources include at least one of a merchant or service provider associated with the goods or services sought;
soliciting responses from the one or more identified information sources based on the request for information;
in response to the solicitation, receiving a set of responses from at least a subset of the one or more identified information sources;
ranking, by operation of a computer processor, each of the received responses based on a comparison of the particular response to the request for information; and
presenting at least a subset of the received responses to the user based on the ranking of the received responses.

2. The method of claim 1, wherein the request for information includes at least one of a natural language request or a free-form text-based request.

3. The method of claim 1, wherein analyzing the request includes categorizing the request into at least one predefined category.

4. The method of claim 1, wherein analyzing the request includes categorizing the request based on at least geographical or vertical information associated with the at least one good or service sought.

5. The method of claim 4, wherein analyzing the request further includes categorizing the request based on one or more of the following: demographic information associated with the user, information associated with a profile of the user, and a user-defined category included in the request.

6. The method of claim 4, wherein identifying one or more information sources as responsive to the request includes identifying one or more information sources associated with at least one category associated with the request.

7. The method of claim 1, wherein each information source is associated with a set of routing information.

8. The method of claim 7, wherein each set of routing information includes a correspondence address and a communication channel associated with the information source.

9. The method of claim 8, wherein each correspondence address includes at least one of a really simple syndication (RSS) feed associated with the information source, an email address for the information source, a chat address associated with the information source, or a short message service (SMS) short code associated with the information source.

10. The method of claim 8, wherein identifying one or more information sources as responsive to the request includes routing a set of information associated with the request for information from the user to at least one identified information source's correspondence address.

11. The method of claim 10, wherein routing the set of information to the one or more information sources includes routing the set of information to a first information source via a first communication channel and routing the set of information to a second information source via a second communication channel.

12. The method of claim 1, wherein ranking each of the received responses includes:
retrieving the stored profile information associated with each of the one or more identified information sources providing responses to the request for information from the user;
calculating a quality score for each received response based at least in part on the stored profile information associated with the information source corresponding to the received response and the contents of the received response; and
sorting the received responses based on the calculated quality scores.

13. The method of claim 12, wherein calculating the quality score for each received response is further based at least in part on a bid value associated with the information source.

14. The method of claim 12, wherein presenting at least a subset of the received responses to the user based on the ranking of the received responses includes:
identifying a predefined number of responses to be presented; and
limiting the subset of the received responses for presentation to the predefined number of responses.

15. The method of claim 1, wherein at least one response from the subset of the one or more identified information sources includes an offer for the good or service sought in the request from the user.

16. An article comprising a computer readable storage medium, the computer readable storage medium storing instructions for causing one or more processors to perform operations including:
storing profile information associated with a plurality of information sources, each information source associated with at least one category;
analyzing a request for information from a user where the request includes information associated with at least one good or service sought;
determining one or more information sources as responsive to the request based at least in part on a comparison of the information associated with the at least one good or service sought and the at least one category associated with each information source, wherein information sources include at least one of a merchant or service provider associated with the goods or services sought;
soliciting responses from the one or more identified information sources based on the request for information;
in response to the solicitation, receiving a set of responses from at least a subset of the one or more identified information sources;
ranking each of the received responses based on a comparison of the particular response to the request for information; and
transmitting at least a subset of the received responses to the user based on the ranking of the received responses.

17. The article of claim 16, wherein analyzing the request includes categorizing the request based on at least geographical or vertical information associated with the at least one good or service sought.

18. The article of claim 16, wherein ranking each of the received responses includes:
retrieving the stored profile information associated with each of the one or more identified information sources providing responses to the request for information from the user;
calculating a quality score for each received response based at least in part on the stored profile information associated with the information source corresponding to the received response and the contents of the received response; and
sorting the received responses based on the calculated quality scores.

19. A system comprising:
one or more analysis servers adapted to:
analyze a request for information from a user where the request includes information associated with at least one good or service sought;
categorize the request for information based on at least geographical or vertical information associated with the at least one good or service sought; and
identify at least one information source as responsive to the request based at least in part on a comparison of the categorization of the request for information with the categorizations associated with a plurality of information source, wherein information sources include at least one of a merchant or service provider associated with the goods or services sought;
one or more routing servers adapted to:
store profile information associated with a plurality of information sources, each information source associated with at least one categorization and a set of routing information;
solicit responses to the request for information by transmitting information associated with the request for information to at least one of the identified information sources, where transmitting the information is based on the set of routing information associated with each solicited information source; and
collect a set of responses to the request for information from at least a subset of the solicited information sources; and
the one or more analysis servers further adapted to:
rank the collected responses based on a quality comparison of each collected response to the request for information from the user; and
transmit at least a subset of the collected responses to the user based on the ranking of the received responses.
